(19) United States
(12) Patent Application Publication
(10) Pub. No.: US 2021/0081541 A1
(43) Pub. Date: Mar. 18, 2021

(54) VULNERABILITY STATE REPORT

(71) Applicant: Hewlett-Packard Development Company, L.P., Spring, TX (US)

(72) Inventors: Shell Simpson, Boise, ID (US); Hal McMillan, Vancouver, WA (US)

(21) Appl. No.: 17/048,339

(22) PCT Filed: Aug. 20, 2018
(86) PCT No.: PCT/US2018/047119

§ 371 Date: Oct. 16, 2020

(51) Int. Cl. G06F 21/57

(52) U.S. Cl. CPC G06F 21/577; G06F 2221/034; G06F 21/572

(57) ABSTRACT

Example implementations relate to creating a vulnerability state report. An example non-transitory machine-readable medium can include instructions executable to determine information associated with a device. The information can include firmware information, device model information, and security bulletin information. The example non-transitory machine-readable medium can include instructions executable to combine the information to determine a vulnerability state of the device and create a report of the vulnerability state of the device. The report can include comprising information associated with the vulnerability state and associated security bulletin information.

### BACKGROUND

Firmware is a class of software that provides low-level control for a device's specific hardware. Firmware can be held in non-volatile memory devices such as read-only memory (ROM), erasable programmable ROM (EPROM), or flash memory. Examples of devices containing firmware include embedded systems, consumer appliances, printing devices, computing devices, and computing device peripherals, among others.

### BRIEF DESCRIPTION OF THE DRAWINGS

FIG. 1 illustrates a system for creating a vulnerability state report according to an example;

FIG. 2 illustrates a diagram of a controller including a processor, a memory resource, and engines according to an example;

FIG. 3 illustrates a display of graphical user interface (GUI) displaying a report according to an example;

FIG. 4 illustrates a display of another GUI displaying a report according to an example;

FIG. 5 illustrates a display of yet another GUI displaying a report according to an example; and

FIG. 6 illustrates a method for creating a vulnerability state report according to an example.

### DETAILED DESCRIPTION

Devices, including printing devices, computing devices, and other devices utilizing firmware can be vulnerable to security issues, such as network vulnerabilities or other security vulnerabilities. Updating firmware can address these vulnerabilities, but consumers may not be aware of out-of-date firmware, unsupported devices, or firmware security bulletins associated with the device and/or firmware, Firmware security bulletins provide summaries of vulnerabilities associated with particular versions of firmware (and/or software). The bulletins can be released by a firmware or device provider, among others. The bulletins can include information regarding the firmware versions affected, devices affected, updates that can be performed to fix vulnerabilities, and common vulnerability scoring system (CTSS) scores, among other vulnerability, device, and firmware information.

Some approaches to addressing firmware vulnerabilities include manually reviewing security bulletins and checking firmware version on each device against these bulletins. This can be time-consuming, particularly for consumers with large numbers of devices, and it can be an error-prone process, as well. Other approaches include scheduled firmware updates that compare current firmware versions to newest available firmware versions and update in response to a new firmware version discovered. However, these approaches do not consider whether a particular device model is currently supported or how many revisions out-of-date the firmware may be. In addition, these approaches do not determine a vulnerability state of the device based on a combination of the security bulletin information, device support information, and out-of-date revision information.

Examples of the present disclosure can identify firmware vulnerabilities in a plurality of devices by comparing a version of firmware installed on each device against known vulnerabilities. For instance, this can be done by identifying if a device model in question is actively being supported, identifying how many revisions out-of-date associated firmware is, and by determining a vulnerability state of the device based on whether there are bulletins that apply to the device, whether the device model is supported, and how many revisions out-of-date the firmware is for the device.

Some examples of the present disclosure can combine information from a plurality of sources and create a report including a vulnerability state of the device based on that information. The report can include a summary, information about each device, and information about each applicable vulnerability. The summary can provide a breakdown of a percentage of devices that fall into different vulnerability categories, and the device information can include a vulnerability state for each device. The applicable vulnerability information can include the details about the vulnerability and the device impacted.

Examples of the present disclosure can reduce the time and errors of comparing device firmware versions manually against a list of security bulletins. In addition, context including whether or not firmware and/or the device is currently being supported can be provided, along with context including a number of out-of-date revisions the firmware is. The additional context can create a more robust vulnerability state report and can aid in firmware update decision-making.

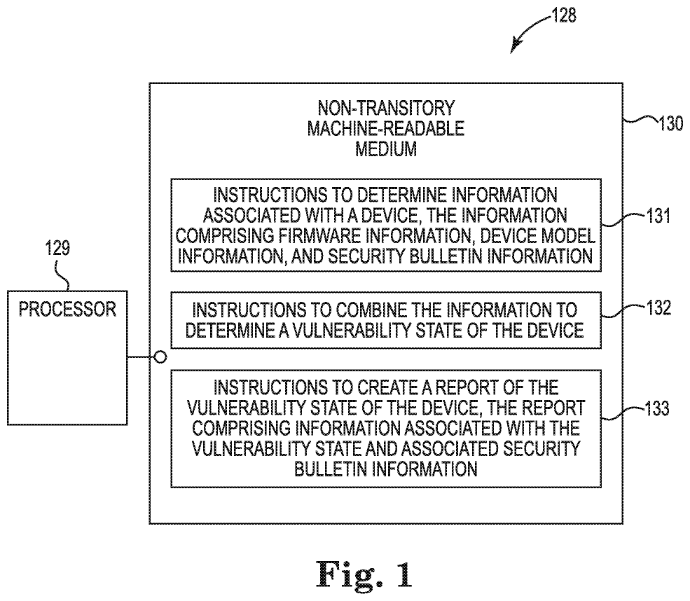

FIG. 1 illustrates a system 128 for creating a vulnerability state report according to an example. System 128 can be a computing device in some examples and can include a processor 129. System 128 can further include a non-transitory machine-readable medium (MRM) 130, on which may be stored instructions, such as instructions 131, 132, and 133. Although the following descriptions refer to a processor and a memory resource, the descriptions may also apply to a system with multiple processors and multiple memory resources. In such examples, the instructions may be distributed (e.g., stored) across multiple non-transitory MRMs and the instructions may be distributed (e.g., executed by) across multiple processors.

Non-transitory MRM 130 may be electronic, magnetic, optical, or other physical storage device that stores executable instructions. Thus, non-transitory MRM 130 may be, for example, Random Access Memory (RAM), an Electrically-Erasable Programmable ROM (EEPROM), a storage drive, an optical disc, and the like on-transitory MRM 130 may be disposed within system 128, as shown in FIG. 1. In this example, the executable instructions 131, 132, and 133 can be “installed” on the device. Additionally and/or alternatively, non-transitory MRM 130 can be a portable, external or remote storage medium, for example, that allows system 128 to download the instructions 131, 132, and 133 from the portable/external/remote storage medium. In this situation, the executable instructions may be part of an “installation package”. As described herein, non-transitory MRM 130 can be encoded with executable instructions for vulnerability state report creation.

Instructions 131, when executed by a processor such as processor 129, can include instructions to determine information associated with a device, the information comprising firmware information, device model information, and security bulletin information. For instance, firmware information can include a release name, release, date, and a product family, among others. Device model information can include a model name, product family, and whether or not the device model is supported, among others. Security bulletin information can include an identifier, a description, a URL, device models affected, and firmware versions affected, among others. Other information associated with the device may be determined, for instance, including device model numbers/names, serial numbers, firmware versions, and customer information.

Instructions 132, when executed by a processor such as processor 129, can include instructions to combine the information to determine a vulnerability state of the device. For instance, the aforementioned information associated with the device can be used to determine a vulnerability state of each device. For instance, the vulnerability states can include an “OK” state that includes the device having no known security bulletins associated therewith, the device having current firmware support, and the device having no more than one firmware revision out-of-date.

A different vulnerability state may be an “out-of-date” state. This can include the device having no known security bulletins associated therewith, the device having current firmware support, and the device having a plurality of firmware revisions out-of-date. A “reactive support” vulnerability state can include the device having no known security bulletins associated therewith, and the device having no current firmware support.

In some examples, a “bulletin” vulnerability state can include the device having a known security bulletin associated therewith, and a “not evaluated” vulnerability state can include instances in which a vulnerability state is unknown and/or cannot be determined base on the device having insufficient information associated therewith. For instance, a user may have changed the device model number to an unrecognizable name or number that cannot be identified and/or verified. While, “OK”, “out-of-date”, “reactive support”, “bulletin”, and “not evaluated” are used here, other names may be assigned to vulnerability states, and more or fewer vulnerability states may be used.

In some examples, a device can have more than one vulnerability state and/or have overlapping vulnerability states. For instance, a device may have a security bulletin associated therewith, but also be supported and have one firmware revision out-of-date. This example may fall into a “bulletin” state, but also overlaps with an “OK” state. In such an example, one of the plurality of vulnerability states of the device can be prioritized over another to be the vulnerability state of the device. For instance, because a “bulletin” state is more severe than an “OK” state, the “bulletin” state may be prioritized over the “OK” state. In some examples, vulnerability states can be prioritized based on severity, with the order of severity (from most severe to least severe) being, “bulletin”, “out-of-support”, “reactive support”, and “OK”. Prioritization is not limited to this ordering, however.

Instructions 133, when executed by a processor such as processor 129, can include instructions to create a report of the vulnerability state of the device, the report comprising information associated with the vulnerability state and associated security bulletin information. For instance, the report can include information about the device (e.g., serial number, product name, current firmware version, newest available firmware version, etc.), its associated vulnerability state (e.g., revisions out-of-date, number of associate bulletins, reactive support status, etc.), and bulletin information (e.g., number of associated bulletins, links to relevant security bulletins, etc.).

In some instances, the report can include information about a plurality of devices, such as printing devices, associated with a customer. For instance, a customer may have a plurality of printing devices, and the report can illustrate the vulnerability state of each printing device. The customer or other user, in some examples, can view the report via a GUI and can interact with the report. For instance, the customer or other user may choose to sort the report based on a number of out-of-date revisions associated with the plurality of printing devices.

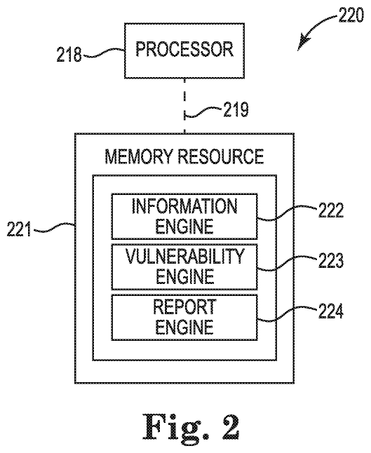

FIG. 2 illustrates a diagram of a controller 220 including a processor 218, a memory resource 221, and engines 222, 223, and 224 according to an example. For instance, the controller 220 can be a combination of hardware and instructions for vulnerability state report creation. The hardware, for example can include a processor 218 and/or a memory resource 221 (e.g., MRM, computer-readable medium (CRM), data store, etc.).

The processor 218, as used herein, can include a number of processing resources capable of executing instructions stored by a memory resource 221. The instructions (e.g., machine-readable instructions (MRI)) can include instructions stored on the memory resource 221 and executable by the processor 218 to implement a desired function (e.g., creating a vulnerability state report). The memory resource 221, as used herein, can include a number of memory components capable of storing non-transitory instructions that can be executed by processor 218. Memory resource 221 can be integrated in a single device or distributed across multiple devices. Further, memory resource 221 can be fully or partially integrated in the same device as processor 218 or it can be separate but accessible to that device and processor 218. Thus, it is noted that the controller 220 can be implemented on an electronic device and/or a collection of electronic devices, among other possibilities.

The memory resource 221 can be in communication with the processor 218 via a communication link (e.g., path) 219, The communication link 219 can be local or remote to an electronic device associated with the processor 218. The memory resource 221 includes engines (e.g., information engine 222, vulnerability engine 223, and report engine 224). The memory resource 221 can include more engines than illustrated to perform the various functions described herein.

The engines 222, 223, and 224 can include a combination of hardware and instructions to perform a number of functions described herein (e.g., creating a vulnerability state report). The instructions (e.g., software, firmware, etc.) can be downloaded and stored in a memory resource (e.g., MRM) as well as a hard-wired program (e.g., logic), among other possibilities.

Information engine 222 can determine information associated with a plurality of devices. The information, for instance, can include firmware information, device model information, and firmware security bulletin information. The device model information can include information associated with active firmware support of the device model, and the firmware information can include information associated with out-of-date firmware revisions. For instance, the determination can include whether the device model is actively supported or not (e.g., if the device and its firmware is old and no longer actively supported) and how many out-of-date firmware revisions are associated with the device.

Determining the information, in some examples, can include harvesting information from a plurality of databases including device lists with model identifiers, serial numbers, and firmware versions for each device. The determination can also include grouping the products by program (e.g., related products, products running the same firmware, etc.) and/or determining to which program each one of the plurality of devices belongs. Using that information, determinations can be made as to whether the program is actively updated (e.g., whether the firmware is actively updated) or if the program is no longer supported. Determining the information, in some instances, can include collecting information about how the firmware is updated.

In some examples, determining firmware security bulletin information includes determining which of the plurality of devices has a firmware security bulletin associated therewith. For instance, a determination can be made as to which bulletins affect which devices. For instance, if a customer has devices A, B, and C, it can be determined which (if any) of a plurality of firmware security bulletins affects any or all of devices A, B, and C. Out another way, firmware security bulletins can be associated with particular firmware releases, which are associated with particular devices.

Vulnerability engine 223 can determine a vulnerability state of a plurality of vulnerability states for each one of the plurality of devices based on the information associated with the plurality of devices. For example, using information including the active firmware support information, the out-of-date firmware revisions information, and the firmware security bulletins information, a vulnerability state of can be determined. In some examples, a vulnerability state can be determined from a plurality of states such as “OK”, “out-of-date”, “reactive support”, “bulletin”, and “not evaluated”, as described with respect to FIG. 1. In some examples, another vulnerability state can include “no data” in which data on a particular device has not been collected and/or is not available.

Report engine 224 can create a sortable report of the plurality of devices, the report comprising the vulnerability state of each one of the plurality of devices, a percentage of the devices having each one of the plurality of vulnerability states, and firmware security bulletin information for each one of the plurality of devices. For instance, the report can include factors taken into consideration when determining a vulnerability state. The report can be sortable such that a user can sort his or her vulnerability state results based on vulnerability state, bulletin, location of devices, and CVSS score, among others.

For instance, if a user has thousands of computing devices and/or printing devices in a plurality of locations around the world, a sorting option can be beneficial to determine which regions need updating and/or which particular devices need updating. This can result in time and cost savings as compared to manually checking each one of the thousands of devices against firmware security bulletins. In addition, manual checking does not take into consideration the combination of factors such as active firmware support, out-of-date firmware revisions, and firmware security bulletins.

In some examples, the report can be displayed via a GUI, and the display can include a list of the plurality of devices. For each of one of the plurality of devices, displayed can be a count of associated firmware security bulletins, a number of associated out-of-date firmware revisions, and a current device support status. A count of associated firmware security bulletins can include the number of firmware security bulletins that are associated with firmware on that particular device (e.g., 0, 1, 2, etc.). This can be helpful in determining how important immediate updating of firmware is (e.g., as a part of the vulnerability state determination).

A number of associated out-of-date firmware revisions can include how many revisions have been missed by and/or not implemented on the device. For instance, if the device is two revisions behind, it may have two associated out-of-date firmware revisions. The higher the number of out-of-date firmware revisions, the more at-risk the device. A current device support status can include a determination of whether the device and/or its firmware is currently supported. If not (e.g., the device is very old), the risk of security issues rises, as does the vulnerability state severity.

The displayed report, in some instance, can allow for interaction by a user, including the aforementioned sorting of the report. The visualization of the report can illustrate which devices and firmware are at a highest risk for security issues. This can encourage users to update firmware. In addition, it can allow for a user to see a state of their devices, which can result in time and cost savings as compared to other security issue detection approaches. In some instances, along with an associated firmware security bulletin count, a hyperlink may be available via the GUI to link a user to associated security bulletin(s).

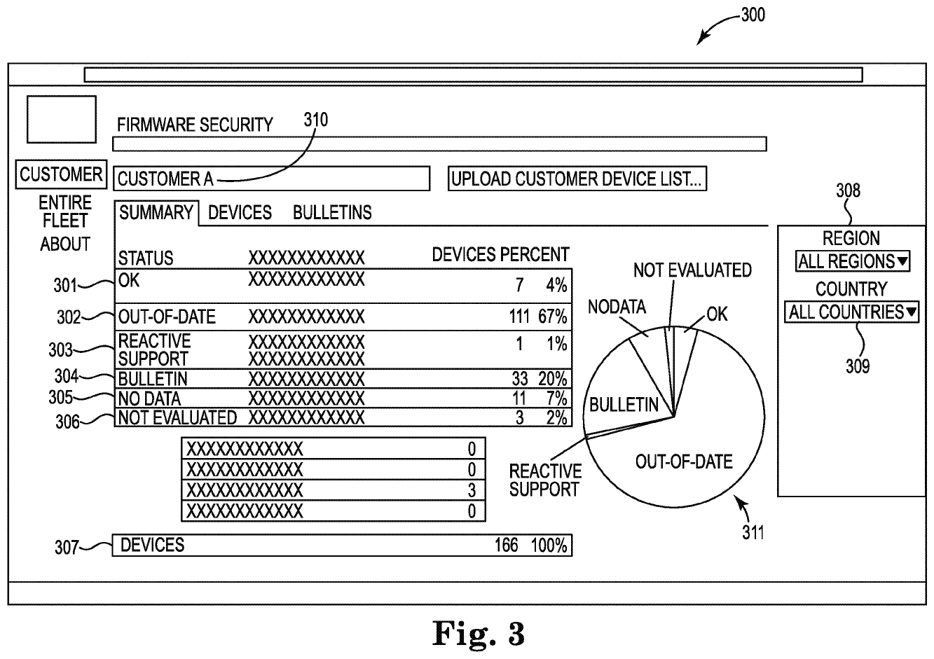

FIG. 3 illustrates a display 300 of a GUI displaying a report according to an example. At 310, a user can enter a customer name (e.g., “Customer A”), and a summary of the customer's device vulnerability states 301, 302, 303, 304, 305, and 306 can be displayed. Each vulnerability state 301, 302, 303, 304, 305, and 306 can include an associated description, as well as the number of devices having that particular vulnerability state and the percentage of the total devices having that vulnerability state. For instance, “bulletin” vulnerability state 304 includes devices with firmware having a known security bulletin associated therewith. Customer A has 33 devices with a “bulletin” vulnerability state 304, which makes up 20 percent of the 166 total devices (e.g., as illustrated at 307). Pie chart 311 illustrates the percentage breakdown of each of the devices and associated vulnerability states 301, 302, 303, 304, 305, and 306.

In some examples, the results can be sorted by region at 308 or by country at 309. For instance, if Customer A has devices in a plurality of countries, he or she may want to sort by country to determine the vulnerability states of his devices in the United States or Canada, for example. Customer A may have regions within the United States, in some instances, and he or she may want to sort results based on the Midwest region to determine which of those devices may be ready for firmware upgrades.

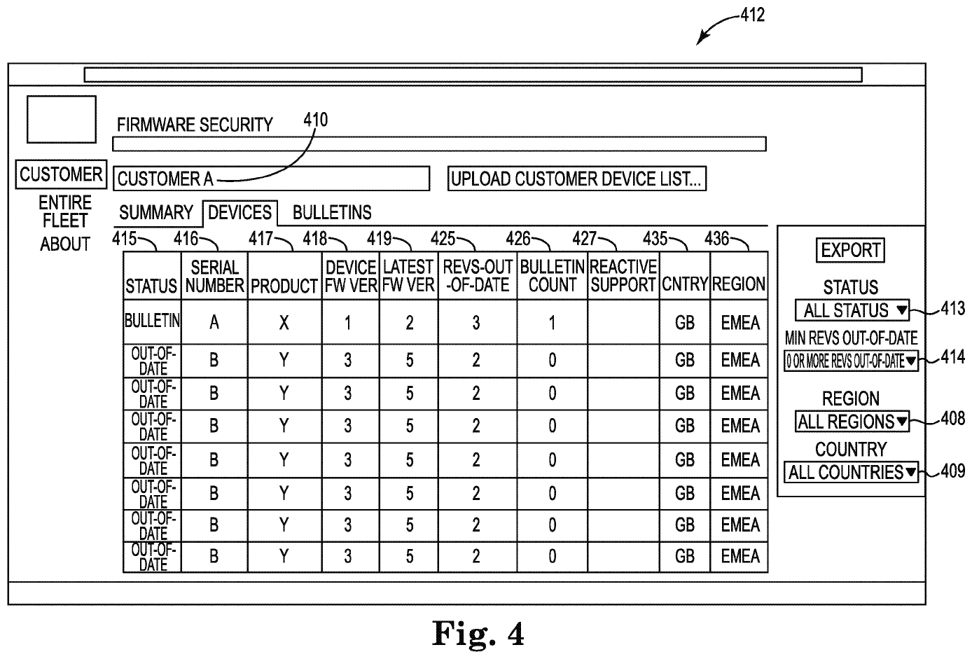

FIG. 4 illustrates a display 412 of another GUI displaying a report according to an example. Similar to display 300 of FIG. 3, a user can enter customer information at 410. In response, display 412 can include a detailed report of vulnerability states at 415, devices at 417 and their associated serial numbers at 416, associated current firmware versions at 418, a latest firmware version at 419, the number of associated firmware revisions that are out-of-date at 425, an associated bulletin count at 426, a reactive support status at 427, an associated country at 435, and an associated region at 436. For instance, device X has a vulnerability state of “bulletin” and a serial number A. The current firmware version of device X is 1, and the latest firmware version is 2. Device X has 3 firmware revisions that are out-of-date and one associated firmware security bulletin. The reactive support status is null, meaning device X is supported (a status of “true” may indicate a device is not supported). Device X is located in Great Britain in the EMEA region.

As illustrated in FIG. 4, a customer such as Customer A may have a plurality of the same device (e.g., device Y), such that it is illustrated a plurality of times in the report. The vulnerability state 415, along with the other aspects are identical for the devices that are the same. In some examples, the results of display 412 can be sorted by vulnerability state at 413, by a threshold number of out-of-date firmware revisions at 414, by region at 408, or by country at 409.

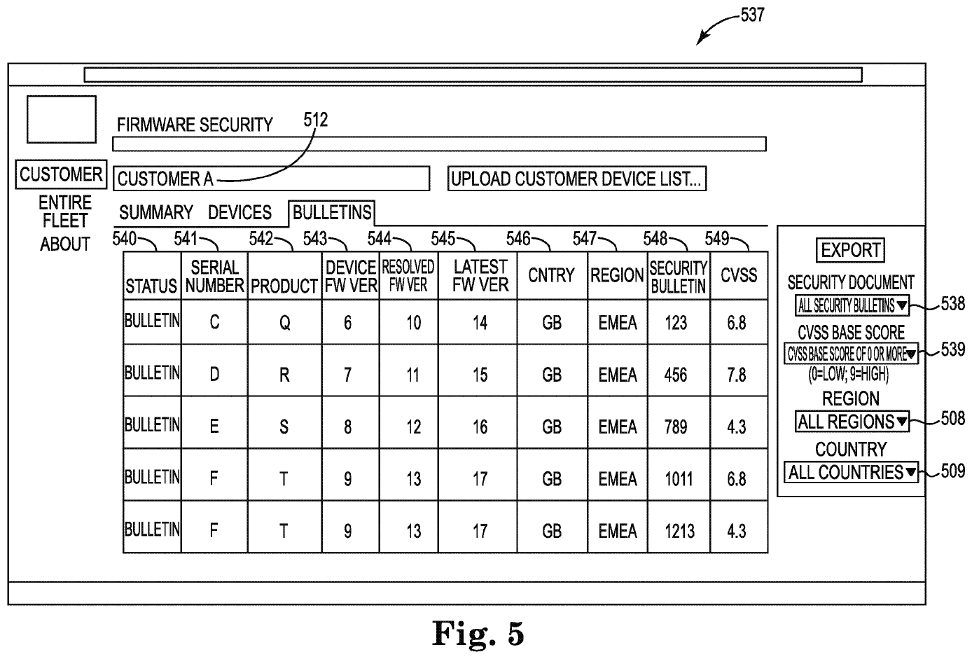

FIG. 5 illustrates a display 537 of yet another GUI displaying a report according to an example. At 512, a user can enter a customer name and a report can be generated that is focused on firmware security bulletins. For instance, for each device at 542, a vulnerability state can be displayed at 540, along with the device serial number at 541, a current device firmware version at 543, a resolved firmware version at 544, a latest firmware version at 545, a country at 546, a region at 547, a CVSS at 549, and a security bulletin identifier at 548. For instance, device Q having serial number C and vulnerability state “bulletin”, the current associated firmware version is 6, while the resolved firmware version is 10 and the latest firmware version is 14. Product Q is located in Great Britain in region EMEA. Product Q is also associated with bulletin 123 and has a CVSS score of 6.8. The CVSS score is a standardized score provided in a bulletin to classify the security risk/importance affecting the firmware. In some examples, column 548 can include hyperlinks to the particular bulletin associated with each one of the plurality of devices.

In some instances, the results in the report of display 537 can be sorted by region at 508 or by country at 509. At 538, the results can be sorted by firmware security bulletin (e.g., a choice as to which bulletin(s) to display can be made) or by CVSS score at 539. For example, a higher CVSS score can indicate a great risk, so by sorting by a high score, it may be determined which devices are most at risk and may be updated first to address vulnerabilities.

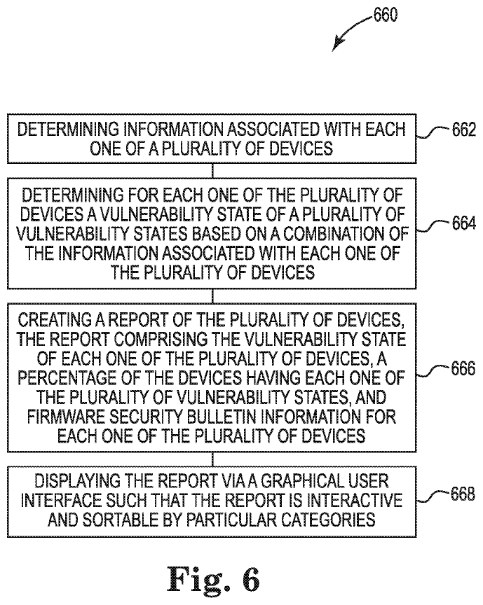

FIG. 6 illustrates a method 660 for creating a vulnerability state report according to an example. At 662, method 660 can include determining information associated with each one of a plurality of devices. The information can include, for instance, whether firmware of each one of the plurality of devices is actively supported, whether a firmware revision of each one of the plurality of devices is out-of-date, and whether each one of the plurality of devices has a firmware security bulletin associated therewith.

In some examples, determining whether each one of the plurality of devices has a firmware security bulletin associated therewith can include associated known firmware security bulletins with a particular firmware release associated with each one of the plurality of devices. For instance, a determination can be made as to which bulletins affect which firmware releases, and in response, a determination can be made as to whether the customer has a device associated with those firmware releases.

At 664, method 660 can include determining for each one of the plurality of devices a vulnerability state of a plurality of vulnerability states based on a combination of the information associated with each one of the plurality of devices. For instances, using the aforementioned information, based on vulnerability state guidelines, a vulnerability state can be assigned to each device. For instance, if a device and its associated firmware has no known security bulletins associated therewith, but the firmware is not actively supported, the device can be given a “reactive support” vulnerability state. As previously noted, other vulnerability states can include (but are not limited to) “OK”, “out-of-date”, “bulletin”, “not evaluated”, and “no data”.

Method 660, at 666, can include creating a report of the plurality of devices. The report can include the vulnerability state of each one of the plurality of devices, a percentage of the devices having each one of the plurality of vulnerability states, and firmware security bulletin information for each one of the plurality of devices. For instance, the report can include a summary (e.g., as illustrated in FIG. 3), detailed information about each device (e.g., as illustrated in FIG. 4), and/or detailed information about each vulnerability state and/or firmware security bulletin (e.g., as illustrated in FIG. 5).

At 668, method 660 can include displaying the report via a GUI such that the report is interactive and sortable by particular categories. For instance, the display can be interactive such that a user can enter customer information and sort report results by such categories as vulnerability state, region, country, out-of-date firmware revisions, bulletin, and CVSS score, among others. Put another way, a request can be received from a user via the GUI to sort the report by an associated firmware security bulletin, number of out-of-date firmware revisions, or a CVSS score. The report can be sorted responsive to the request, and the sorted report can be displayed via the GUI.

Such a display can provide motivation for updating firmware. For instance, a plurality of categories can be used to determine a device vulnerability score, including out-of-date firmware revisions and active support statuses, which can result in more accurate vulnerability predictions as compared to approaches that do not take these into consideration. For instance, the categories can be combined and transformed to a vulnerability state for a particular device. A user can use these predictions and vulnerability states to determine which devices may be updated at particular times. This can reduce time and costs for updating and investigating vulnerabilities as compared to other approaches that are not as detailed and do not allow for reports based on the plurality of categories.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature may refer to one or more of such elements and/or features.

What is claimed:

1. A non-transitory computer readable medium containing instructions executable by a processor to cause the processor to:
determine information associated with a device, the information comprising firmware information, device model information, and security bulletin information;
combine the information to determine a vulnerability state of the device; and
create a report of the vulnerability state of the device, the report comprising information associated with the vulnerability state and associated security bulletin information.

2. The medium of claim 1, wherein the instructions executable to combine the information to determine a vulnerability state comprise instructions executable to prioritize one of a plurality of vulnerability states of the device to be the vulnerability state of the device.

3. The medium of claim 1, wherein the vulnerability state comprises the device having no known security bulletins associated therewith, the device having current firmware support, and the device having no more than one firmware revision out-of-date.

4. The medium of claim 1, wherein the vulnerability state comprises the device having no known security bulletins associated therewith, the device having current firmware support, and the device having a plurality of firmware revisions out-of-date.

5. The medium of claim 1, wherein the vulnerability state comprises the device having no known security bulletins associated therewith, and the device having no current firmware support.

6. The medium of claim 1, wherein the vulnerability state comprises the device having a known security bulletin associated therewith.

7. The medium of claim 1, wherein the vulnerability state comprises an unknown vulnerability state in response to the device having insufficient information associated therewith.

8. A controller comprising a processor in communication with a memory resource including instructions executable to:
determine information associated with a plurality of devices, the information comprising firmware information, device model information, and firmware security bulletin information;
determine a vulnerability state of a plurality of vulnerability states for each one of the plurality of devices based on the information associated with the plurality of devices; and
create a sortable report of the plurality of devices, the report comprising the vulnerability state of each one of the plurality of devices, a percentage of the devices having each one of the plurality of vulnerability states, and firmware security bulletin information for each one of the plurality of devices.

9. The controller of claim 8, wherein the plurality of devices comprises a plurality of printing devices.

10. The controller of claim 8, wherein:
the device model information further comprises information associated with active firmware support of the device model; and
the firmware information further comprises information associated with out-of-date firmware revisions.

11. The controller of claim 8, wherein the instructions executable to determine firmware security bulletin information comprise instructions executable to determine which of the plurality of devices has a firmware security bulletin associated therewith.

12. The controller of claim 8, further comprising instructions executable to display the report via a graphical user interface, the display comprising:
a list of the plurality of devices; and
for each one of the plurality of devices:
a count of associated firmware security bulletins;
a number of associated out-of-date firmware revisions; and
a current device support status.

13. A method, comprising:
determining information associated with each one of a plurality of devices, the information comprising:
whether firmware of each one of the plurality of devices is actively supported;
whether a firmware revision of each one of the plurality of devices is out-of-date; and
whether each one of the plurality of devices has a firmware security bulletin associated therewith;
determining for each one of the plurality of devices a vulnerability state of a plurality of vulnerability states based on a combination of the information associated with each one of the plurality of devices;
creating a report of the plurality of devices, the report comprising the vulnerability state of each one of the plurality of devices, a percentage of the devices having each one of the plurality of vulnerability states; and firmware security bulletin information for each one of the plurality of devices; and
displaying the report via a graphical user interface such that the report is interactive and sortable by particular categories.

14. The method of claim 13, wherein determining whether each one of the plurality of devices has a firmware security bulletin associated therewith comprises associating known firmware security bulletins with a particular firmware release associated with each one of the plurality of devices.

15. The method of claim 13, further comprising:
receiving a request from a user, via the graphical user interface, to sort the report by an associated firmware security bulletin, number of out-of-date firmware revisions, or a common vulnerability scoring system score;
sorting the report responsive to the request; and
displaying the sorted report via the graphical user interface.
